(19) United States
(12) Patent Application Publication
(10) Pub. No.: US 2008/0225782 A1
(43) Pub. Date: Sep. 18, 2008

(54) METHOD AND APPARATUS FOR PERFORMING BLIND TRANSPORT FORMAT DETECTION

(75) Inventors: Jin Wang, Central Islip, NY (US); Peter S. Wang, East Setauket, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/047,363

(22) Filed: Mar. 13, 2008

Related U.S. Application Data
(60) Provisional application No. 60/894,931, filed on Mar. 15, 2007.

(51) Int. Cl. H04Q 7/00

(52) U.S. Cl. 370/329

(57) ABSTRACT

Methods and apparatus for performing efficient blind transport format (TF) detection in wireless communication systems are disclosed based on TF groups and efficient hybrid automatic repeat request (HARQ) assisted blind TF detection for retransmissions. When a receiver detects a failure for an initial transmission, a transmitter receives an HARQ negative acknowledgement (NACK) or no feedback from the receiver beyond a certain duration. The transmitter uses the same transport format combination (TFC) for a first retransmission as is used for the initial transmission for data detection, and if the first retransmission fails and after the transmitter gets the HARQ NACK or no feedback from the receiver beyond the certain duration, the transmitter uses a next more robust TFC for a second retransmission and the receiver should also to use next more robust TFC for data detection for the second retransmission from the transmitter. Alternatively, the transmitter uses the next robust TF for the first retransmission.

### CROSS REFERENCE TO RELATED APPLICATION

This application claims the benefit of U.S. Provisional Application No. 60/894,931 filed Mar. 15, 2007, which is incorporated by reference as if fully set forth.

### FIELD OF THE INVENTION

The present invention is related to wireless communication systems.

### BACKGROUND

The evolved universal terrestrial radio access (E-UTRA) and universal terrestrial radio access network (UTRAN), among other things, seeks to develop a radio access network with a high-data-rate, low-latency, packet-optimized system with improved capacity and coverage. In order to achieve this, an evolution of the radio interface as well as the radio network architecture is desired. For example, instead of using code division multiple access (CDMA) which is currently used in Third Generation Partnership Project (3GPP) systems, orthogonal frequency division multiple access (OFDMA) and frequency division multiple access (FDMA) are proposed as air interface technologies for use in the downlink and uplink transmissions respectively. One modification is that all packet switched services in LTE, including all voice calls, are performed on a packet switched basis. This leads to many challenges in designing an LTE system to support voice over Internet protocol (VoIP) service.

If a user application requires sporadic resources, e.g. hypertext transfer protocol (HTTP) traffic, the system resources (i.e., time and bandwidth) are best utilized if they are assigned on an as-needed basis. In that case, the resources are explicitly assigned and signaled by the layer 1 (L1) control channel. If either the type of service, the quality of service (QoS) profile, or the application requires a periodic or a continuous allocation of resources (such as VoIP), then periodic or continuous signaling of assigned physical (PHY) resources may be avoided if persistent allocations are allowed. A persistent allocation is a PHY resource assignment that is valid until an explicit de-allocation is performed. Persistent allocation may be implemented to reduce L1/layer 2 (L2) control channel overhead.

LTE uses a shared data channel system where the resources are dynamically assigned to different wireless transmit/receive units (WTRUs) on a per transmission timing interval (TTI) basis through the use of L1/L2 control channels. However, L1/L2 control channel signaling may be inefficient in the transfer of small packets because of the associated overhead, especially for delay sensitive services like VoIP.

Consequently, several signaling optimized downlink (DL) scheduling approaches have been proposed in the radio access network 2 (RAN2) standard to reduce the L1/L2 control channel overhead. One such proposed DL scheduling approach relates to signaling the optimized DL scheduling based on blind channel detection.

The following discussion uses an LTE system as an example, however, the methods and apparatus disclosed herein are also applicable to a high-speed packet access (HSPA) system when similar services and concepts are supported.

When persistent or semi-persistent scheduling is used for a real-time service such as VoIP in an LTE system, blind transport format (TF) detection may be implemented to reduce the signaling overhead, such as the overhead associated with L1/L2 signaling. Blind TF detection may also be used during the initial transmission and during retransmissions. In blind TF detection, the size of the received frame is estimated by the WTRU, blindly, using only the received frame. During normal TF detection, the Node-B transmits the information regarding the transport format combination (TFC) to the WTRU prior to the WTRU's reception of the data packet, so the WTRU knows which TFC is used for the transmitted data allowing it to decode the data. For blind TF detection, there is no TFC information for the upcoming data packet, so when the WTRU receives the data packet the WTRU attempt to read the data using different TFCs in order to decode the received data. This process to decode data packet by trying different TFCs is called blind TF detection. While blind TF detection may reduce the signaling overhead, it may also result in additional complexity and an increased memory requirement for the WTRU, which is undesirable. An efficient procedure for blind TF detection in a wireless system is therefore desired.

### SUMMARY

Methods and apparatus for performing blind TF detection in wireless communication systems are disclosed herein. In a first method, a data transmission is received, the receiver identifies a TF subgroup associated with the received data transmission and then performs blind TF detection on the received data transmission within the subgroup.

### BRIEF DESCRIPTION OF THE DRAWINGS

A more detailed understanding may be had from the following description, given by way of example in conjunction with the accompanying drawings wherein:

FIG. 1 is an example wireless communication system including a plurality of wireless transmit/receive units (WTRUs), a Node-B, and a radio network controller (RNC);

FIG. 2 is a functional block diagram of a WTRU and the Node-B of FIG. 1;

FIG. 3 is an example TF table for a two level blind TF detection procedure;

FIG. 4 is a flowchart of a two level blind TF detection method;

FIG. 5 shows a flowchart of a blind TF detection procedure based on the channel conditions;

FIG. 6 shows a proposed TF table defined according to robustness; and

FIG. 7 shows a HARQ assisted TFC selection and detection for retransmissions.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

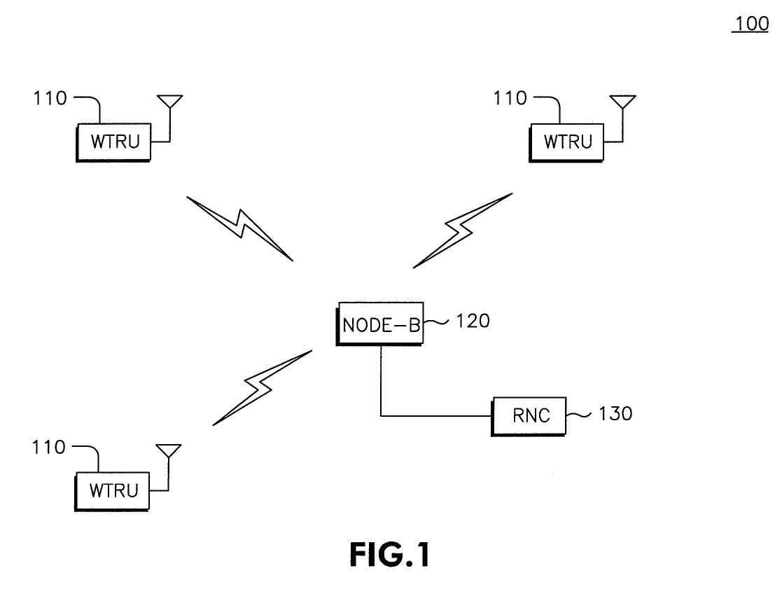

FIG. 1 shows a wireless communication network 100 including a plurality of WTRUs 110 and a Node-B 120. As shown in FIG. 1, the WTRUs 110 are in communication with the Node-B 120. Although three WTRUs 110 and a Node-B 120 are shown in FIG. 1, it should be noted that any combination of wireless and wired devices may be included in the wireless communication network 100.

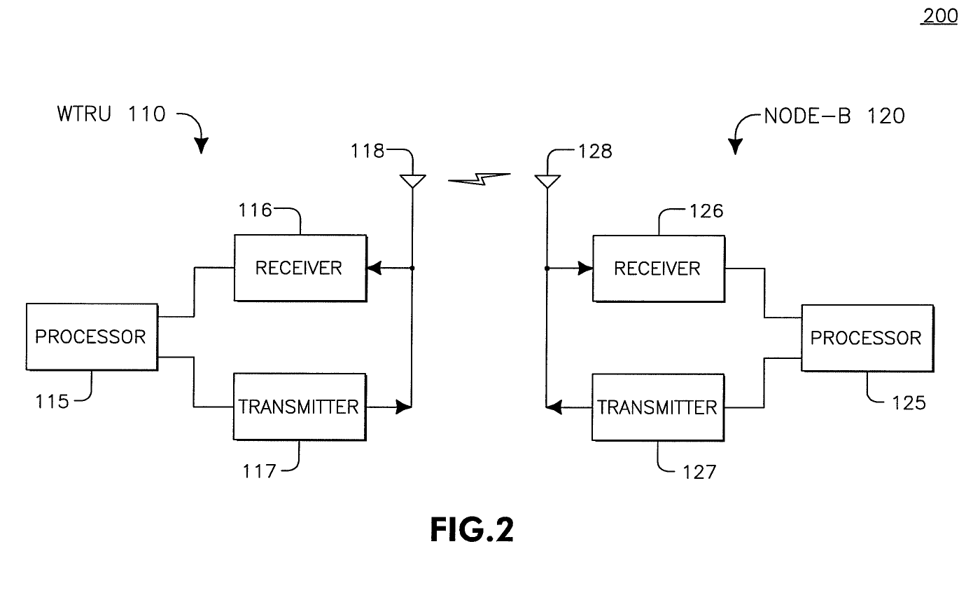

FIG. 2 is a functional block diagram 200 of a WTRU 110 and the Node-B 120 of the wireless communication network 100 of FIG. 1. As shown in FIG. 2, the WTRU 110 is in communication with the Node-B 120 and both are configured to perform a method for blind TF detection.

In addition to the components that may be found in a typical WTRU, the WTRU 110 includes a processor 115, a receiver 116, a transmitter 117, and an antenna 118. The processor 115 is configured to perform a method for blind TF detection. The receiver 116 and the transmitter 117 are in communication with the processor 115. The antenna 118 is in communication with both the receiver 116 and the transmitter 117 to facilitate the transmission and reception of wireless data.

In addition to the components that may be found in a typical Node-B, the Node-B 120 includes a processor 125, a receiver 126, a transmitter 127, and an antenna 128. The processor 125 is configured to perform a method for blind TF detection. The receiver 126 and the transmitter 127 are in communication with the processor 125. The antenna 128 is in communication with both the receiver 126 and the transmitter 127 to facilitate the transmission and reception of wireless data.

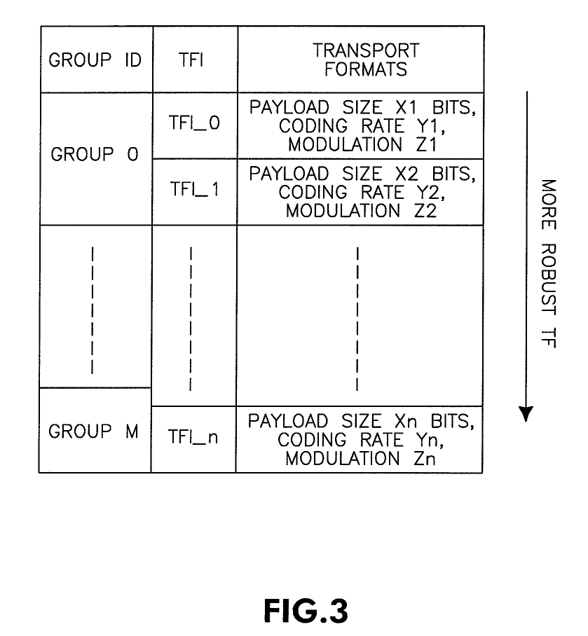

FIG. 3 is an example TF table for a two level blind TF detection procedure. The term two level refers to a process where the first level comprises detecting a subgroup associated with received data, and the second level comprises detecting the exact TFC from a defined of TFCs associated with the subgroup. The TF table, shown in FIG. 3, is divided into m+1 groups, each with a group identifier. Each group may contain multiple TFCs. For example, group 0 comprises two TFCs, which are identified by the corresponding transport format identifier (TFI). Each TFC may have its own payload size, coding rate and modulation rate for the data contained therein. The TF table is ordered from the least robust TFC to the most robust TFC. A more robust TFC means the TFC can provide the data packet more reliable error protection capability. For example a low modulation scheme such as quadrature phase-shift keying (QPSK), a low coding rate such as ⅓ coding rate can provide more reliable error detection and correction capability at the WTRU 110. A low modulation and coding scheme is generally used when channel condition is poor and robust detection and correction is needed at the WTRU 110. However a high modulation scheme and high coding rate will provide less error detection and correction capability and thus is usually used when channel condition is favorable. The TF table may be standardized and preprogrammed into the equipment or alternatively it may be dynamically, statically, or semi-statically created and signaled through the air-interface via radio resource control (RRC) signaling. Alternatively, the TF table can also be signaled through broadcast signaling and L1/L2 signaling.

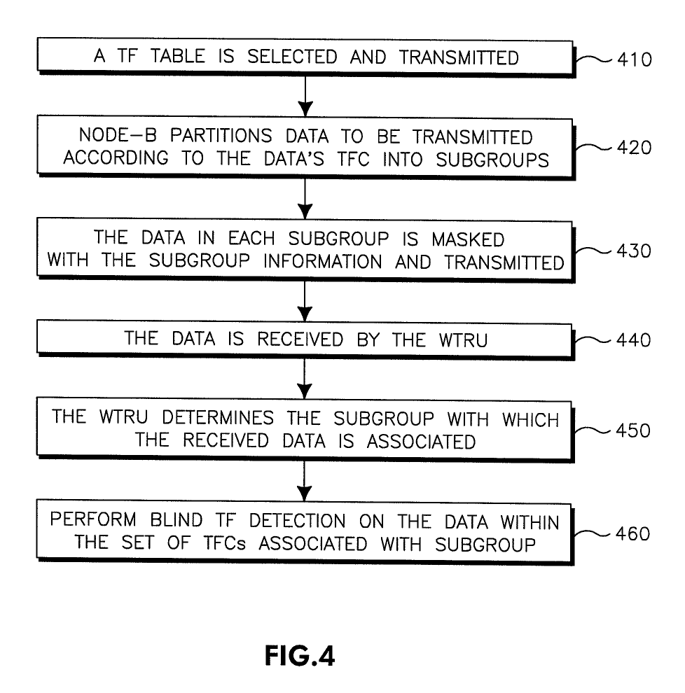

FIG. 4 is a flowchart of a two level blind TF detection method. A TF table is selected and then it is transmitted to a WTRU 110 during the subscription process (block 410). The Node-B 120 examines the TFCs of data to be transmitted and partitions the data into subgroups, e.g., group 0-group m, based on the TFC of the data (block 420). Each subgroup includes several TFCs which are consecutively located in the TF table. The number of TFI's within each subgroup is the same. For each subgroup a group ID is assigned. The subgroup to TFI matching table is pre-defined and the Node-B 120 only needs to examine each data packet to see which subgroup the data packet falls in. The data in each subgroup is masked with the appropriate subgroup information, e.g. a TFI, and transmitted (block 430). The data, including the masked subgroup information, is received by the WTRU 110 (block 440). Based on the masked subgroup information, the WTRU 110 determines the subgroup with which the received data is associated (block 450). After the subgroup of the data is determined, the WTRU 110 performs blind TF detection on the data to detect the exact TFC used for transmission within the set of TFCs associated with the subgroup (block 460). For example, if the there are eight total TFCs allowable for a data transmission according to a TF table, these eight TFCs can be partitioned by the Node-B 120 into two subgroups with each subgroup contain four TFCs. The WTRU 120 then detects which of the two subgroups a data transmission is in. Then, a WTRU 110 would need only to blindly detect the TFC from within a group of four possible TFCs in a subgroup instead of from the eight possible TFCs for a whole group.

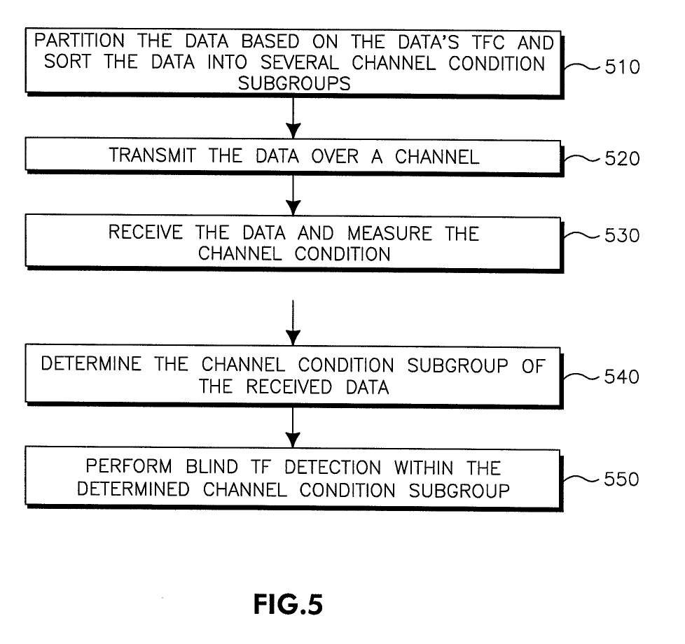

FIG. 5 shows a flowchart of a blind TF detection procedure based on the channel conditions. The Node-B 120 knows the channel condition based on a channel quality indicator (CQI) report. The CQI report is transmitted from the WTRU 110 to the Node-B 120 periodically and assists the Node-B 120 in determining the channel condition. The Node-B 120 can then make the TFC selection for the initial transmission and retransmissions. The Node-B 120 partitions the data based on the data's TFC, and sorts the data into several channel condition subgroups (block 510). The number and condition requirements for the subgroups may be signaled to the WTRU 110 or be pre-coded. The channel conditions subgroups comprise: bad, average, and good, (the actual number of subgroups may be based on the granularity of channel condition partitions). The Node-B 120 transmits the data over a channel (block 520). The WTRU 110 receives the data and then measures the channel condition of the channel over which the data was received (block 530). Based on the channel measurement result, the WTRU 110 can determine the channel condition subgroup associated with the received data (block 540). The WTRU 110 then performs the blind TF detection within the determined channel condition subgroup to determine the TFC of the received data (block 550). Therefore, when a Node-B receives a CQI indicating poor channel conditions, it may switch to a more robust TFC and when the CQI indicates good channel conditions, a less robust TFC may be used allowing greater throughput.

If the TFC changes occur during retransmissions, some advanced physical layer signal processing techniques may be needed to implement blind TF detection to maintain the accuracy and reduce the detection delay. However, this may introduce complexity for the WTRU 110. To alleviate physical signal detection burden at the WTRU 110, a HARQ feedback may be used to assist the TFC selection decision at both the Node-B 120 and the WTRU 110. Thus, the WTRU 110 predicts by default what type of TFC is expected for the following retransmissions and avoids the blind TF detection.

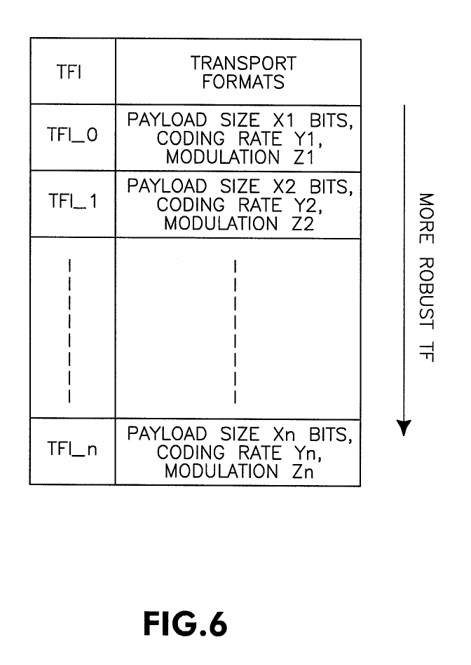

In accordance with the following two embodiments for TFC selection and detection to be used at the Node-B 120 and WTRU 110, the network may decide which procedure to use and signal which procedure will be used for the service. This decision may be transmitted inside the RRC signaling during establishment of service. FIG. 6 shows a proposed TF table defined according to robustness. Each TFC may have its own payload size, coding rate and modulation rate. Each TFC includes a TFI.

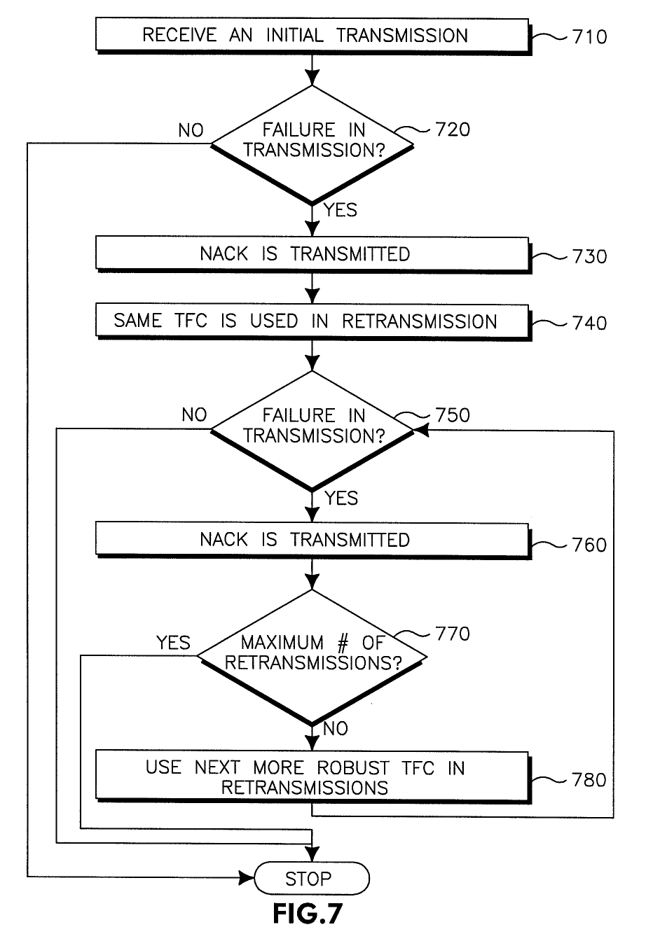

FIG. 7 shows an example TFC selection and detection procedure for retransmissions. Prior to an initial transmission, a Node-B 120 and a WTRU 110 may agree upon the TFC to be used during the initial transmission. Referring to FIG. 7, the initial transmission is received by the WTRU 110 (block 710). The WTRU 110 determines whether a failure has occurred in the initial transmission (block 720). A HARQ NACK is received by the Node-B 120 (block 730). Alternatively, an implicit NACK may be used, where the Node-B 120 interprets a NACK when it receives no feedback for a predetermined time interval. If a NACK was received, the Node-B 120 transmits the data using the same TFC for the first retransmission, and the WTRU 110 uses the same TFC used for the data detection (block 740). The WTRU 110 receives the first retransmission and then determines whether a failure has occurred in the retransmission (block 750). The Node-B 120 receives the HARQ NACK, or alternatively a predetermined time elapses (block 760). A determination is made as to whether the maximum number of retransmissions is reached (block 770). If the maximum number of retransmissions has not been reached, then the Node-B 120 uses the next more robust TFC in the TF table for the subsequent retransmission and the WTRU 110 should also to use next more robust TFC in the TF table for data detection for the second retransmission from the Node-B 120 (block 780). The process is continued until the transmission is successful or a maximum number of retransmissions is reached.

In another embodiment, if the WTRU 110 detects a failure in an initial transmission and the Node-B 120 receives an explicit or implicit HARQ NACK, then the Node-B 120 uses the next more robust TFC in the TF table for the first retransmission, and the WTRU 110 also use the next more robust TFC in the TF table for data detection of the first retransmission. If the first retransmission fails, the Node-B 120 receives an explicit or implicit HARQ NACK, then the Node-B 120 uses the next more robust TFC in the TF table for the second retransmission, and the WTRU 110 also uses the next more robust TFC in the TF table of data detection for the second retransmission. This process is repeated until transmission is successful or until the maximum number of retransmissions is reached.

If either of above two options are determined and synchronized between the Node-B 120 and the WTRU 110, then the WTRU 110 may know the detection process, which may alleviate the burden for blind TF detection.

While the embodiments shown above describe a Node-B 120 in communication with a WTRU 110, wherein the WTRU 110 must use blind TF detection to determine the TFC, this is shown as an example. The methods and processes disclosed may be performed by a WTRU signaling a Node-B on the uplink wherein the Node-B must use blind TF detection. In another embodiment, multiple WTRUs may communicate with each other in a mesh network, wherein both are configured to perform blind TF detection and TFC selection.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for blind transport format (TF) detection, the method comprising:
receiving a data transmission, including masked TF subgroup data;
identifying a TF subgroup associated with the data transmission based on the masked TF subgroup data;
searching a TF table to determine a plurality of transport format combinations (TFCs) associated with the TF subgroup; and
determining a TFC, from the plurality of TFCs, used for the data transmission using blind TF detection.

2. The method of claim 1, wherein the TF table is standardized and preprogrammed.

3. The method of claim 1, wherein the TF table is received through broadcast signaling.

4. The method of claim 1, wherein the TF table is ordered from a least robust TFC to a most robust TFC.

5. A method for blind transport format (TF) detection, the method comprising:
receiving a data transmission over a channel;
measuring a channel condition of the channel;
determining a TF subgroup associated with the data transmission based on the channel condition;
searching a TF table to determine a plurality of transport format combinations (TFCs) associated with the TF subgroup; and
determining a TFC, from the plurality of TFCs, used for the data transmission using blind TF detection.

6. The method of claim 5, wherein the TF table is standardized and preprogrammed.

7. The method of claim 5, wherein the TF table is received through broadcast signaling.

8. The method of claim 5, further comprising:
generating a channel quality indicator (CQI) report; and
transmitting the CQI report.

9. The method of claim 8, wherein the CQI report is transmitted periodically.

10. A method for transport format (TF) selection, the method comprising:
receiving a data transmission;
detecting a failure in the data transmission, using a first transport format combination (TFC) from a TF table;
transmitting a hybrid automatic repeat request (HARQ) negative acknowledgement (NACK);
receiving a first retransmission;
detecting a failure for the first retransmission, using the first TFC;
transmitting a HARQ NACK; and
selecting a second TFC from the TF table during a subsequent retransmission, wherein the second TFC is more robust than the first TFC.

11. The method of claim 10, wherein the TF table is standardized and preprogrammed.

12. The method of claim 10, wherein the TF table is received through broadcast signaling.

13. A method for transport format (TF) selection, the method comprising:
receiving a data transmission:
detecting a failure in the data transmission, using a first transport format combination (TFC);
transmitting a hybrid automatic repeat request (HARQ) negative acknowledgement (NACK);
receiving a first data retransmission; and
detecting a failure for the first data retransmission using a second TFC, wherein the second TFC is more robust than the first TFC.

14. The method of claim 13, wherein the TF table is standardized and preprogrammed.

15. The method of claim 13, wherein the TF table is received through broadcast signaling.

16. A wireless transmit/receive unit (WTRU), the WTRU comprising:
a memory configured to store a transport format (TF) table;
a receiver configured to receive a data transmission, including masked TF subgroup data; and
a processor configured to identify a TF subgroup associated with the data transmission based on the masked TF subgroup data, to search the TF table to determine a plurality of transport format combinations (TFCs) associated with the TF subgroup and to determine the TFC, from the plurality of TFCs, used for the data transmission using blind TF detection.

17. The WTRU of claim 16, wherein the TF table is standardized and preprogrammed into the memory.

18. The WTRU of claim 16, wherein the TF table is received through broadcast signaling.

19. A wireless transmit/receive unit (WTRU), the WTRU comprising:
a memory configured to store a transport format (TF) table;
a receiver configured to receive a data transmission over a channel; and
a processor configured to measuring a channel condition of the channel, to determine a TF subgroup associated with the data transmission based on the channel condition, to search the TF table to determine a plurality of transport format combinations (TFCs) associated with the TF subgroup, and to determining a TFC, from the plurality of TFCs, used for the data transmission using blind TF detection.

20. The WTRU of claim 19, wherein the TF table is standardized and preprogrammed.

21. The WTRU of claim 19, wherein the TF table is received through broadcast signaling.
